(19) United States
(12) Patent Application Publication
(10) Pub. No.: US 2026/0351177 A1
(43) Pub. Date: Nov. 5, 2026

(54) PIXEL, DISPLAY PANEL AND ELECTRONIC DEVICE

(71) Applicant: Samsung Display Co., Ltd., Yongin-si (KR)

(72) Inventors: Sehyun LEE, Yongin-si (KR); Kwihyun KIM, Yongin-si (KR); Kyunghoon CHUNG, Yongin-si (KR)

(73) Assignee: Samsung Display Co., Ltd., Yongin-si (KR)

(21) Appl. No.: 19/653,962

(22) Filed: Apr. 21, 2026

(30) Foreign Application Priority Data
May 2, 2025 (KR) 10-2025-0058491

(51) Int. Cl. G09G 3/3233

(52) U.S. Cl. CPC G09G 3/3233; G09G 2310/08; G09G 2330/021

(57) ABSTRACT

A pixel includes a first transistor, a second transistor connected to a first terminal of the first transistor and a first voltage line, a third transistor connected to a second terminal of the first transistor, a fourth transistor connected to a gate of the first transistor and a second voltage line, a fifth transistor connected to the second terminal of the first transistor and a light-emitting element, a sixth transistor connected to the third transistor and a data line, and a capacitor connected to the gate of the first transistor and the second terminal of the first transistor. A shape, a size, and a material of the first transistor is same as a shape, a size, and a material of the sixth transistor.

### CROSS-REFERENCE TO RELATED APPLICATION

This application is based on and claims priority under 35 U.S.C. § 119 to Korean

Patent Application No. 10-2025-0058491, filed on May 2, 2025, in the Korean Intellectual Property Office, the disclosure of which is incorporated by reference herein in its entirety.

### BACKGROUND

Example embodiments relate to a pixel, a display device including the same, and an electronic device.

Recently, display devices have been used in a greater variety of ways. In addition, display devices have become thinner and lighter, and thus, their range of use has widened.

As display devices are used in various ways, various methods may be used to design the forms of display devices, and the number of functions that may be applied or linked to display devices has been increasing.

### SUMMARY

Some example embodiments include a high-resolution display device. However, such a technical problem is an example, and one or more example embodiments are not limited thereto.

Additional aspects will be set forth in part in the description which follows and, in part, will be apparent from the description, or may be learned by practice of the presented embodiments of the disclosure.

According to some example embodiments, a pixel includes a first transistor, a second transistor connected to a first terminal of the first transistor and a first voltage line, a third transistor connected to a second terminal of the first transistor, a fourth transistor connected to a gate of the first transistor and a second voltage line, a fifth transistor connected to the second terminal of the first transistor and a light-emitting element, a sixth transistor connected to the third transistor and a data line, and a capacitor connected to the gate of the first transistor and the second terminal of the first transistor. The first transistor and the sixth transistor have the same structure. A shape, a size, and a material of the first transistor is same as a shape, a size, and a material of the sixth transistor.

In an embodiment, a gate of the sixth transistor may be connected to the data line.

In an embodiment, the third transistor may be connected between the second terminal of the first transistor and the sixth transistor.

In an embodiment, the pixel may further include a seventh transistor connected to the light-emitting element and the second voltage line.

In an embodiment, the first to sixth transistors may be transistors of the same channel type.

In an embodiment, the first to sixth transistors may be N-channel transistors.

In an embodiment, the third transistor and the fourth transistor may be configured to transmit a data signal from the data line, through the sixth transistor, to the second terminal of the first transistor during a writing period in which the third transistor and the fourth transistor are turned on.

In an embodiment, the second terminal of the first transistor is configured to receive a compensation voltage during the writing period. The compensation voltage may be a difference between a voltage corresponding to the data signal and a threshold voltage of the sixth transistor.

In an embodiment, the gate of the first transistor may be configured to receive the compensation voltage during an emission period following the writing period and in which the second transistor and the fifth transistor are turned on, and the second transistor and the fifth transistor are turned on.

In an embodiment, the fourth transistor, the fifth transistor, and the seventh transistor may be configured to be turned on during a first period, and the second transistor and the third transistor may be configured to be turned off during the first period. The third transistor and the fourth transistor may be configured to be turned on during a second period, and the second transistor, the fifth transistor, and the seventh transistor may be configured to be turned off during the second period. The second transistor and the fifth transistor may be configured to be turned on during an emission period following the second period, and the third transistor, the fourth transistor, and the seventh transistor may be configured to be turned off during the emission period.

According to one or more example embodiments, in a display panel including a plurality of pixels, each of the plurality of pixels comprises a first transistor, a second transistor connected to a first terminal of the first transistor and a first voltage line, a third transistor connected to a second terminal of the first transistor, a fourth transistor connected to a gate of the first transistor and a second voltage line, a fifth transistor connected to the second terminal of the first transistor and a light-emitting element, a sixth transistor connected to the third transistor and a data line, and a capacitor connected to the gate of the first transistor and the second terminal of the first transistor. The first transistor and the sixth transistor have the same structure. A shape, a size, and a material of the first transistor is same as a shape, a size, and a material of the sixth transistor.

In an embodiment, a gate of the sixth transistor may be connected to the data line.

In an embodiment, each of the plurality of pixels may further include a seventh transistor connected to the light-emitting element and the second voltage line.

In an embodiment, the first to sixth transistors may be N-channel transistors.

In an embodiment, the third transistor and the fourth transistor may be configured to transmit a data signal from the data line, through the sixth transistor, to the second terminal of the first transistor during a writing period in which the third transistor and the fourth transistor are turned on.

In an embodiment, the second terminal of the first transistor may be configured to receive a compensation voltage during the writing period, and the compensation voltage may be a difference between a voltage corresponding to the data signal and a threshold voltage of the sixth transistor.

In an embodiment, the gate of the first transistor may be configured to receive the compensation voltage during an emission period following the writing period and in which the second transistor and the fifth transistor may be turned on, and the second transistor and the fifth transistor may be turned on.

According to one or more example embodiments, an electronic device includes a controller configured to receive an on-operation signal from a processor and output a control signal based on the on-operation signal, a gate driver configured to receive the control signal and sequentially output at least one gate signal, and a display panel including a plurality of pixels configured to receive the at least one gate signal. Each of the plurality of pixels comprises a first transistor, a second transistor connected to a first terminal of the first transistor and a first voltage line, a third transistor connected to a second terminal of the first transistor, a fourth transistor connected to a gate of the first transistor and a second voltage line, a fifth transistor connected to the second terminal of the first transistor and a light-emitting element, a sixth transistor connected to the third transistor and a data line, a seventh transistor connected to the light-emitting element and the second voltage line, and a capacitor connected to the gate of the first transistor and the second terminal of the first transistor. The first transistor and the sixth transistor have the same structure. A shape, a size, and a material of the first transistor is same as a shape, a size, and a material of the sixth transistor.

In an embodiment, a gate of the sixth transistor may be connected to the data line.

In an embodiment, the gate driver is configured to supply a first gate signal including a first gate-on voltage to a gate of the fourth transistor during a first period, supply a second gate signal including a second gate-on voltage to a gate of the fifth transistor during the first period, supply a third gate signal including a third gate-on voltage to a gate of the seventh transistor during the first period, supply a fourth gate signal including a fourth gate-on voltage to a gate of the third transistor during a second period following the first period, supply the first gate signal including the first gate-on voltage to the gate of the fourth transistor during the second period, supply a fifth gate signal including a fifth gate-on voltage to a gate of the second transistor during an emission period following the second period, and supply the second gate signal including the second gate-on voltage to the gate of the fifth transistor during the emission period. The first transistor and an electrode of the light-emitting element of each of the plurality of pixels may be configured to receive a voltage input to the second voltage line during the first period, the second terminal of the first transistor may be configured to receive, through the sixth transistor, a compensation voltage during the second period, the compensation voltage may be a difference between a voltage corresponding to a data signal input to the data line and a threshold voltage of the sixth transistor, and the gate of the first transistor may be configured to receive the compensation voltage during the emission period, and light may be emitted at a luminance corresponding to a driving current based on the compensation voltage.

### BRIEF DESCRIPTION OF THE DRAWINGS

The above and other aspects, features, and advantages of some example embodiments of the disclosure will be more apparent from the following description taken in conjunction with the accompanying drawings, in which:

FIGS. 1A and 1B are schematic diagrams of a display device according to some example embodiments;

FIG. 2 is a schematic diagram of a display device according to some example embodiments;

FIG. 3 is a schematic equivalent circuit diagram of a pixel according to some example embodiments;

FIG. 4 is a timing diagram for describing operations of the pixel of FIG. 3 according to some example embodiments;

FIG. 5 is a block diagram of an electronic device according to some example embodiments; and

FIG. 6 is a schematic diagram of electronic devices according to various embodiments.

### DETAILED DESCRIPTION

Reference will now be made in detail to example embodiments, examples of which are illustrated in the accompanying drawings, wherein like reference numerals refer to like elements throughout. In this regard, some example embodiments may have different forms and should not be construed as being limited to the descriptions set forth herein. Accordingly, the example embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the present description allows for various changes and numerous example embodiments, some example embodiments will be illustrated in the drawings and described in the written description. Effects and features of one or more example embodiments and methods of accomplishing the same will become apparent from the following detailed description of the one or more example embodiments, taken in conjunction with the accompanying drawings. However, some example embodiments may have different forms and should not be construed as being limited to the descriptions set forth herein.

While such terms as “first” and “second” may be used to describe various elements, such elements must not be limited to the above terms. The above terms are used only to distinguish one element from another.

The singular forms “a,” “an,” and “the” as used herein are intended to include the plural forms as well unless the context clearly indicates otherwise.

It will be understood that the terms “include,” “comprise,” and “have” as used herein specify the presence of stated features or elements but do not preclude the addition of one or more other features or elements.

It will be further understood that, when a layer, region, or element is referred to as being on another layer, region, or element, it may be directly or indirectly on the other layer, region, or element. That is, for example, intervening layers, regions, or elements may be present.

As used herein, the expression “A and/or B” refers to A, B, or A and B. In addition, the expression “at least one of A and B” refers to A, B, or A and B.

As used herein, when it is referred that X and Y are connected, it may include the case where X and Y are electrically connected, the case where X and Y are functionally connected, and the case where X and Y are physically connected. In this regard, X and Y may include objects (e.g., apparatuses, devices, circuits, wirings, electrodes, terminals, conductive layers, layers, etc.). Therefore, connection is not limited to a preset connection relationship, for example, not limited to a connection relationship illustrated in the drawings or detailed descriptions, and may include other connection relationships not illustrated in the drawings or detailed descriptions.

For example, the case where X and Y are electrically connected may be a case where X and Y are connected so that electrical signals may be transmitted to each other, and may include a case where X and Y are electrically connected while in direct contact with each other and a case where one or more elements (e.g., a switch, a transistor, a capacitor, an inductor, a resistor, a diode, etc.) that allow electrical connection between X and Y are connected between X and Y.

As used herein, the term “ON” used in association with the state of a device may denote an activated state of the device, and the term “OFF” may denote an inactivated state of the device. The term “ON” used in association with a signal received by a device may denote a signal activating the device, and the term “OFF” may denote a signal inactivating the device. A device may be activated by a high-level voltage or a low-level voltage. For example, a P-channel transistor (a P-type transistor) is activated by a low-level voltage, and an N-channel transistor (an N-type transistor) is activated by a high-level voltage. Therefore, it should be understood that “ON” voltages for a P-type transistor and an N-type transistor are opposite (low versus high) voltage levels.

The direction x, the direction y, and the direction z are not limited to directions along three axes of the rectangular coordinate system and may be interpreted in a broader sense. For example, the direction x, the direction y, and the direction z may be perpendicular to one another or may represent different directions that are not perpendicular to one another.

Sizes of elements in the drawings may be exaggerated or reduced for convenience of explanation. For example, since sizes and thicknesses of elements in the drawings are arbitrarily illustrated for convenience of description, the following example embodiments are not limited thereto.

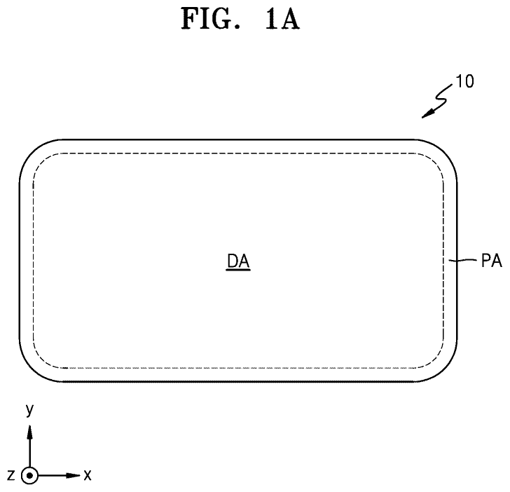

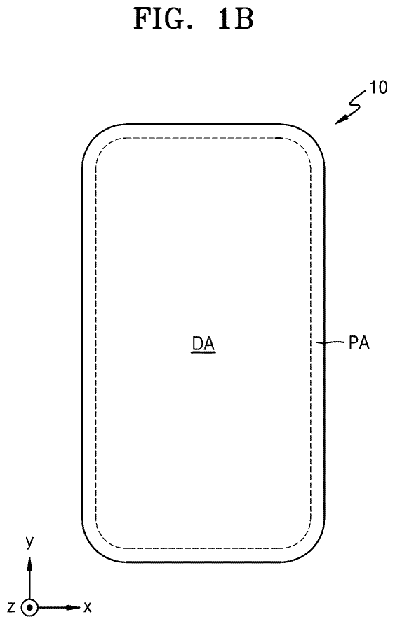

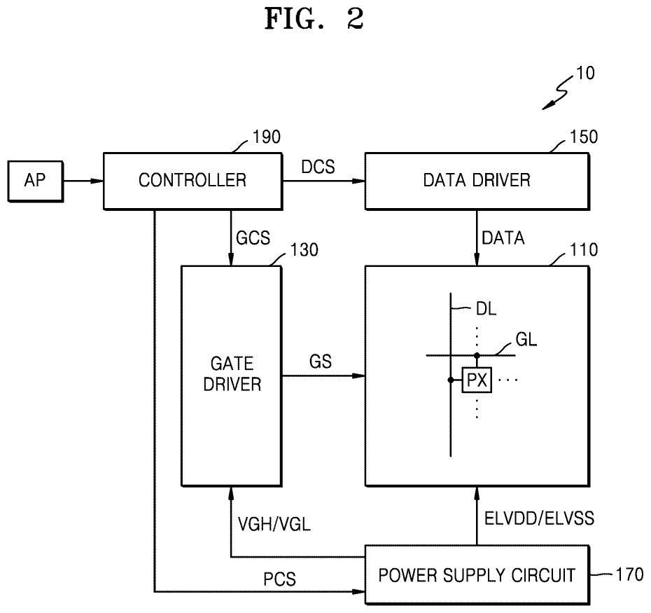

FIGS. 1A and 1B are schematic diagrams of a display device 10 according to some example embodiments. FIG. 2 is a schematic diagram of the display device 10 according to some example embodiments.

Referring to FIGS. 1A and 1B, the display device 10 may include a display area DA displaying an image and a peripheral area PA outside the display area DA. The display area DA may be entirely surrounded by the peripheral area PA.

In a plan view of the display area DA, the display area DA may have a rectangular shape. In some example embodiments, the display area DA may have a polygonal shape, such as a triangle, a pentagon, or a hexagon, a circular shape, an oval shape, or an atypical shape. Corners of edges of the display area DA may have round shapes. In some example embodiments, the display area DA of the display device 10 may have a length in the direction x that is greater than a length in the direction y, as shown in FIG. 1A. In some example embodiments, the display area DA of the display device 10 may have a length in the direction y that is greater than a length in the direction x as shown in FIG. 1B.

The display device 10 is a device displaying a moving image or a still image, and may visually provide information to a user. The display device 10 according to some example embodiments may be a display device, such as an organic light-emitting display, an inorganic light-emitting display (or an inorganic electroluminescent (EL) display), or a quantum dot light-emitting display. However, example embodiments are not limited thereto.

Referring to FIG. 2, the display device 10 may include a display panel 110. The display panel 110 may include a substrate, and a plurality of gate lines GL, a plurality of data lines DL, and a plurality of pixels PX connected thereto may be arranged in the display area DA of the substrate. The plurality of pixels PX may be repeatedly arranged in a first direction (direction x, row direction) and a second direction (direction y, column direction). Each of the plurality of pixels PX may include an organic light-emitting diode as a display element, and the organic light-emitting diode may be connected to a pixel circuit. The pixel circuit may include a plurality of transistors and at least one capacitor. Each pixel PX may be connected to a corresponding gate line among the plurality of gate lines GL and a corresponding data line among the plurality of data lines DL.

Each of the gate lines GL may extend in the direction x (row direction) and may be connected to pixels PX positioned in the same row. Each of the gate lines GL may be configured to transmit a gate signal to the pixels PX of the same row. Each of the data lines DL may extend in the direction y (column direction) and may be connected to pixels PX positioned in the same column. Each of the data lines DL may be configured to transmit a data signal to each of the pixels PX of the same column in synchronization with the gate signal.

Various conductive lines configured to transmit an electrical signal to be applied to the display area DA, outer driving circuits electrically connected to pixel circuits, and pads to which a printed circuit board or a driver integrated circuit (IC) chip is attached may be positioned in the peripheral area (a non-display area) PA outside the display area DA of the display panel 110. The outer driving circuits may include a gate driver 130, a data driver 150, a power supply circuit 170, and a controller 190.

In some example embodiments, the gate driver 130, the data driver 150, the power supply circuit 170, and the controller 190 may be mounted on the display panel 110 as a driving chip. In some example embodiments, the data driver 150, the power supply circuit 170, and the controller 190 may each be formed as an individual IC chip or may be formed as a single IC chip, and may be arranged on a flexible printed circuit board (FPCB) electrically connected to a pad arranged on one side of a substrate constituting the display panel 110. In some example embodiments, the data driver 150, the power supply circuit 170, and the controller 190 may be directly arranged on a substrate in a chip-on-glass (COG) or chip-on-plastic (COP) manner. However, example embodiments are not limited thereto.

In some example embodiments, part of the gate driver 130 or the entire gate driver 130 may be directly formed in a peripheral area of a substrate during a process of forming a transistor constituting the pixel circuit in a display area of the substrate. The gate driver 130 may include an amorphous silicon TFT gate driver circuit (ASG), a low temperature polycrystalline silicon (LTPS) TFT gate driver circuit, or an oxide semiconductor TFT gate driver circuit (OSG) internalized in the display panel 110. The gate driver 130 may be connected to the plurality of gate lines GL and may be configured to generate a gate signal GS in response to a gate driving control signal GCS from the controller 190 and sequentially supply the same to the gate lines GL. The gate line GL may be connected to a gate of a transistor included in the pixel PX, and the gate signal GS may be a gate control signal for controlling the turn-on and turn-off of a transistor to which a gate line is connected. The gate signal GS may include a gate-on voltage at which the transistor may be turned on and a gate-off voltage at which the transistor may be turned off. In some example embodiments, the gate driving control signal GCS may include a start signal and a plurality of clock signals. In some example embodiments, the gate driver 130 may be arranged to the left and/or right of the display area DA.

The data driver 150 may be connected to the plurality of data lines DL and may be configured to generate a data signal DATA in response to a data driving control signal DCS from the controller 190. The data signal DATA may be transmitted to pixel circuits of the pixels PX through the data line DL. The data signal DATA input to the data lines DL may be input to the pixels PX to which a gate signal is input. The data driver 150 may be configured to convert input image data having a gray scale input from the controller 190 into the data signal DATA in the form of voltage or current. In some example embodiments, the data driving control signal DCS may include a start signal and a plurality of clock signals.

The power supply circuit 170 may be configured to generate signals (voltage and current) required to drive the pixels PX in response to a power driving control signal PCS from the controller 190.

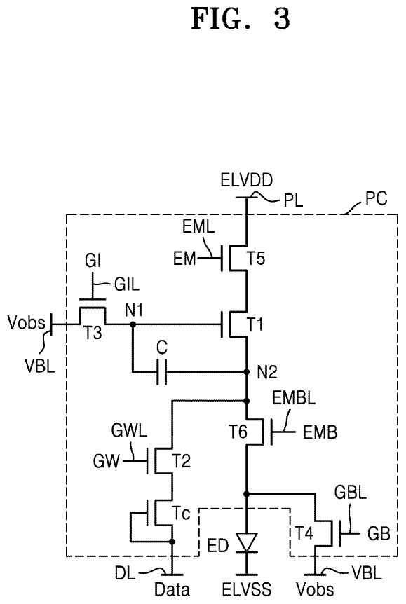

When the display device 10 is an organic light-emitting display, the power supply circuit 170 may be configured to supply a first power voltage ELVDD and a second power voltage ELVSS. The first power voltage ELVDD may be applied to the pixel circuits of the pixels PX through a driving voltage line arranged in the display area DA, and the second power voltage ELVSS may be applied to an opposite electrode of the display element. The first power voltage ELVDD may be a high-level voltage that is provided to one terminal of a driving transistor connected to a first electrode (a pixel electrode or an anode) of the organic light-emitting diode of each pixel PX. The second power voltage ELVSS may be a low-level voltage that is provided to a second electrode (an opposite electrode or a cathode) of the organic light-emitting diode. The first power voltage ELVDD and the second power voltage ELVSS may be driving voltages that allow the plurality of pixels PX to emit light. The power supply circuit 170 may be configured to generate a bias voltage Vobs (refer to FIG. 3) and supply the same to the pixels PX.

The power supply circuit 170 may be configured to generate a high-level voltage VGH and a low-level voltage VGL and supply the same to the gate driver 130.

The controller 190 may generate the gate driving control signal GCS, the data driving control signal DCS and the power driving control signal PCS, based on signals input from the outside. The controller 190 may supply the gate driving control signal GCS to the gate driver 130, may supply the data driving control signal DCS to the data driver 150, and may supply the power driving control signal PCS to the power supply circuit 170.

In some example embodiments, the display device 10 may be connected to a processor of an electronic device. The processor may include an application processor AP. The controller 190 may receive an on-operation signal, for example, a power-on signal and/or an operation flag signal, from the application processor AP. When the electronic device turns power-on or awakens from a sleep mode due to a user, the controller 190 may receive an on-operation signal from the application processor AP and may generate the gate driving control signal GCS, the data driving control signal DCS, and the power driving control signal PCS based on the on-operation signal and output the same.

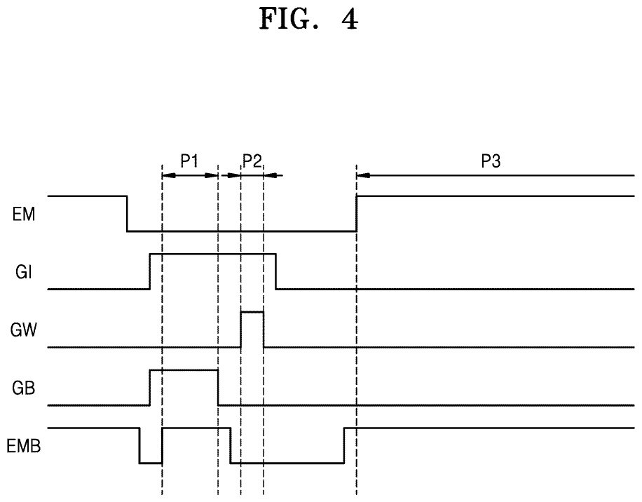

FIG. 3 is a schematic equivalent circuit diagram of the pixel PX according to some example embodiments. FIG. 4 is a timing diagram for describing operations of the pixel PX of FIG. 3 according to some example embodiments.

Referring to FIG. 3, the pixel PX may include a pixel circuit PC and a light-emitting diode ED as a display element connected to the pixel circuit PC.

The pixel circuit PC may include first to seventh transistors T1 to T6 and Tc and a capacitor C. Signal lines connected to the pixel circuit PC may include the data line DL, a first gate line GWL, a second gate line GIL, a third gate line GBL, a fourth gate line EML, a fifth gate line GBL, a driving voltage line PL, and a bias voltage line VBL.

The first transistor T1 may be a driving transistor in which the magnitude of source-drain current is determined according to a gate-source voltage Vgs, and the second to sixth transistors T2 to T6 may be switching transistors that are turned on/turned off according to a gate-source voltage, substantially, a gate voltage. The first to sixth transistors T1 to T6 may be implemented as thin-film transistors. Depending on the type (P-type or N-type) and/or operation conditions of a transistor, a first terminal of each of the first to sixth transistors T1 to T6 may be a source or drain, and a second terminal thereof may be a terminal that is different from the first terminal. For example, when the first terminal is a source, the second terminal may be a drain.

In some example embodiments, at least one of the first to seventh transistors T1 to T6 and Tc may be N-channel transistors. For example, at least the first transistor T1 may be an N-channel transistor. The pixel circuit PC shown in FIG. 3 is an example in which the first to seventh transistors T1 to T6 and Tc are N-channel transistors.

The N-channel transistor may be an oxide thin-film transistor including an oxide semiconductor. A semiconductor of the oxide thin-film transistor may include oxide such as amorphous Indium-Gallium-Zinc-Oxide (IGZO), Zinc-Oxide (ZnO), Titanium Oxide (TiO), etc. A gate-on voltage of a gate signal that turns on the N-channel transistor may be a high-level voltage (a first level voltage), and a gate-off voltage of a gate signal that turns off the N-channel transistor may be a low-level voltage (a second level voltage). However, example embodiments are not limited thereto.

In some example embodiments, the first transistor T1 and the seventh transistor Tc may be N-channel transistors, and at least one of the second to sixth transistors T2 to T6 may be a P-channel transistor. The P-channel transistor may be a silicon thin-film transistor including a silicon semiconductor. A semiconductor of the silicon thin-film transistor may include amorphous silicon, polysilicon, etc. A gate-on voltage of a gate signal that turns on the P-channel transistor may be a low-level voltage (a second level voltage), and a gate-off voltage of a gate signal that turns off the P-channel transistor may be a high-level voltage (a first level voltage).

The first transistor T1 may be connected between the driving voltage line PL and the light-emitting diode ED. The first transistor T1 may be connected to the fifth transistor T5 and the sixth transistor T6. The first transistor T1 may include a gate, a first terminal connected to the driving voltage line PL via the fifth transistor T5, and a second terminal connected to a pixel electrode of the light-emitting diode ED via the sixth transistor T6. The first transistor T1 may output a driving current corresponding to a data signal Data applied to the gate to the first transistor T1. Hereinafter, a node to which the gate of the first transistor T1 is connected may be defined as a first node N1. The first terminal of the first transistor T1 may be a drain, and the second terminal of the first transistor T1 may be a source. A node to which the second terminal of the first transistor T1 is connected may be defined as a second node N2.

The second transistor T2 may be connected between the second node N2 and the data line DL. The second transistor T2 may be connected to the second terminal of the first transistor T1 and the seventh transistor Tc. The second transistor T2 may include a gate connected to the first gate line GWL, a first terminal connected to the second node N2, and a second terminal connected to the seventh transistor Tc. The second transistor T2 may be turned on by a first gate signal GW received through the first gate line GWL to transmit the data signal Data transmitted from the data line DL through the seventh transistor Tc to the second node N2.

The third transistor T3 may be connected to the gate of the first transistor T1 and the bias voltage line VBL. The third transistor T3 may include a gate connected to the second gate line GIL, a first terminal connected to the first node N1, and a second terminal connected to the bias voltage line VBL. The third transistor T3 may be turned on by a second gate signal GI transmitted through the second gate line GIL to transfer the bias voltage Vobs transferred through the bias voltage line VBL to the first node N1 and initialize a voltage of the first node N1.

The fourth transistor T4 may be connected to the light-emitting diode ED and the bias voltage line VBL. The fourth transistor T4 may include a gate connected to the third gate line GBL, a first terminal connected to the light-emitting diode ED, and a second terminal connected to the bias voltage line VBL. The first terminal of the fourth transistor T4 may be connected to the pixel electrode of the light-emitting diode ED. The fourth transistor T4 may be turned on by a third gate signal GB transmitted through the third gate line GBL to transfer the bias voltage Vobs transferred through the bias voltage line VBL to the pixel electrode of the light-emitting diode ED and initialize a voltage of the pixel electrode.

The fifth transistor T5 may be connected to the driving voltage line PL and the first transistor T1. The fifth transistor T5 may include a gate connected to the fourth gate line EML, a first terminal connected to the driving voltage line PL, and a second terminal connected to the first terminal of the first transistor T1. The fifth transistor T5 may be turned on or turned off by a fourth gate signal EM transmitted through the fourth gate line EML.

The sixth transistor T6 may be connected to the first transistor T1 and the light-emitting diode ED. The sixth transistor T6 may include a gate connected to the fifth gate line EMBL, a first terminal connected to the second terminal of the first transistor T1, and a second terminal connected to the light-emitting diode ED. The second terminal of the sixth transistor T6 may be connected to the pixel electrode of the light-emitting diode ED. The sixth transistor T6 may be turned on or turned off according to a fifth gate signal EMB transmitted through the fifth gate line EMBL.

The seventh transistor Tc may be connected between the first transistor T1 and the data line DL. The seventh transistor Tc may be connected to the second transistor T2 and the data line DL. The seventh transistor Tc may include a gate connected to the data line DL, a first terminal connected to the first terminal of the second transistor T2, and a second terminal connected to the data line DL. The seventh transistor Tc may be a diode-connected transistor in which the gate and the second terminal are connected to the data line DL. A voltage of the first terminal of the seventh transistor Tc may be a value obtained by subtracting a threshold voltage Vth of the seventh transistor Tc from a voltage corresponding to the data signal Data (hereinafter, a “data voltage”). The seventh transistor Tc may be a copying transistor having the same structure as that of the first transistor T1.

In some example embodiments, a description that the seventh transistor Tc and the first transistor T1 have the same structure may mean that the shape, size, and material of the seventh transistor Tc are substantially the same as the shape, size, and material of the first transistor T1 and thus device characteristics, for example, threshold voltages, of the seventh transistor Tc and the first transistor T1 are the same as each other. The seventh transistor Tc and the first transistor T1 may be manufactured by the same process simultaneously. The seventh transistor Tc and the first transistor T1 may have a semiconductor layer including a source area, a drain area and a channel area between the source area and the drain area, a gate (a gate electrode), and a source electrode connected to the source area and a drain electrode connected to the drain area. In some example embodiments, the source area may function as a source electrode and the drain area may function as a drain electrode. In some example embodiments, the seventh transistor Tc and the first transistor T1 may be N-channel MOSFET. In some example embodiments, the seventh transistor Tc and the first transistor T1 may be a top-gate transistor or a bottom-gate transistor. In some example embodiments, the seventh transistor Tc and the first transistor T1 may be positioned close to each other to facilitate manufacturing so as to have the same device characteristics. A semiconductor layer of the seventh transistor Tc and a semiconductor layer of the first transistor T1 may be arranged on the same layer. The gate of the seventh transistor Tc and the gate of the first transistor T1 may be arranged on the same layer.

The capacitor C may be connected to the gate of the first transistor T1 and the second terminal of the first transistor T1. The capacitor C may store a voltage corresponding to a voltage difference between the first node N1 and the second node N2.

In some example embodiments, the light-emitting diode ED may be an organic light-emitting diode. The organic light-emitting diode may include a pixel electrode (e.g., an anode) and an opposite electrode (e.g., a cathode) facing the pixel electrode, and the opposite electrode may receive a second driving voltage ELVSS. The organic light-emitting diode may receive a driving current corresponding to the data signal Data from the first transistor T1 and emit light of a certain color, thereby displaying an image.

Referring to FIG. 2, the gate driver 130 may be configured to supply the first to fifth gate signals GW, GI, GB, EM, and EMB to the first to fifth gate lines GWL, GIL, GBL, EML, and EMBL, respectively. The power supply circuit 170 may be configured to supply a first driving voltage ELVDD to the driving voltage line PL, supply the second driving voltage ELVSS to the opposite electrode, and supply the bias voltage Vobs to the bias voltage line VBL.

Operations of the pixel PX shown in FIG. 3 are described below with reference to FIG. 4.

Referring to FIG. 4, during a frame, the pixel PX may perform initialization, compensation, and data writing in a non-emission period and may emit light in an emission period. A period during which the fourth gate signal EM and the fifth gate signal EMB are gate-on voltages may be an emission period. A period during which at least one of the fourth gate signal EM and the fifth gate signal EMB is a gate-off voltage may be a non-emission period. The non-emission period may include a first period P1 and a second period P2. The gate-on voltages of the fourth gate signal EM and the fifth gate signal EMB may be determined according to the channel type of a transistor that receives the fourth gate signal EM and the fifth gate signal EMB. In FIG. 4, the gate-on voltages of the fourth gate signal EM and the fifth gate signal EMB may be first level voltages.

The first period P1 may be an initialization period for initializing the first node N1 to which the gate of the first transistor T1 is connected.

During the first period P1, the first gate signal GW of a second level voltage may be supplied from the gate driver 130 to the first gate line GWL, the second gate signal GI of a first level voltage may be supplied to the second gate line GIL, the third gate signal GB of a first level voltage may be supplied to the third gate line GBL, the fourth gate signal EM of a second level voltage may be supplied to the fourth gate line EML, and the fifth gate signal EMB of a first level voltage may be supplied to the fifth gate line EMBL.

The third transistor T3 may be turned on by the second gate signal GI of a first level voltage, and the gate of the first transistor T1 may be initialized to the bias voltage Vobs.

The fourth transistor T4 may be turned on by the third gate signal GB of a first level voltage, and the sixth transistor T6 may be turned on by the fifth gate signal EMB of a first level voltage. Accordingly, the bias voltage Vobs may be transferred to the pixel electrode of the light-emitting diode ED and the second node N2 to which the second terminal of the first transistor T1 is connected. Because the pixel electrode of the light-emitting diode ED is initialized to the bias voltage Vobs, the first period P1 may be an initialization period for the pixel electrode.

The fifth transistor T5 may be turned off by the fourth gate signal EM of a second level voltage, and a current path between the driving voltage line PL and the first terminal of the first transistor T1 may be blocked. The second transistor T2 may be turned off by the first gate signal GW of a second level voltage, and a current path between the data line DL and the second terminal of the first transistor T1 may be blocked.

The second period P2 may be a compensation period for compensating for a threshold voltage of the first transistor T1 and a writing period (a data programming period) for inputting a data signal.

During the second period P2, the first gate signal GW of a first level voltage may be supplied from the gate driver 130 to the first gate line GWL, the second gate signal GI of a first level voltage may be supplied to the second gate line GIL, the third gate signal GB of a second level voltage may be supplied to the third gate line GBL, the fourth gate signal EM of a second level voltage may be supplied to the fourth gate line EML, and the fifth gate signal EMB of a second level voltage may be supplied to the fifth gate line EMBL.

The gate of the first transistor T1 may be maintained at the bias voltage Vobs by the second gate signal GI of a first level voltage.

The second transistor T2 may be turned on by the first gate signal GW of a first level voltage, and the seventh transistor Tc may be turned on by a data voltage Vdata corresponding to the data signal Data to detect a threshold voltage Vth of the seventh transistor Tc. A value (hereinafter, a “compensation voltage”) Vdata−Vth_tc obtained by subtracting a threshold voltage Vth_tc of the seventh transistor Tc from the data voltage Vdata may be transferred to the second terminal of the first transistor T1 through the turned-on seventh transistor Tc and second transistor T2.

The sixth transistor T6 may be turned off by the fifth gate signal EMB of a second level voltage, and the fifth transistor T5 may be turned off by the fourth gate signal EM of a second level voltage.

A third period P3 may be a period during which the light-emitting diode ED emits light. During the third period P3, the first gate signal GW of a second level voltage may be supplied from the gate driver 130 to the first gate line GWL, the second gate signal GI of a second level voltage may be supplied to the second gate line GIL, the third gate signal GB of a second level voltage may be supplied to the third gate line GBL, the fourth gate signal EM of a first level voltage may be supplied to the fourth gate line EML, and the fifth gate signal EMB of a first level voltage may be supplied to the fifth gate line EMBL.

The second transistor T2 may be turned off by the first gate signal GW of a second level voltage, the third transistor T3 may be turned off by the second gate signal GI of a second level voltage, and the fourth transistor T4 may be turned off by the third gate signal GB of a second level voltage.

The fifth transistor T5 may be turned on by the fourth gate signal EM of a first level voltage, and the sixth transistor T6 may be turned on by the fifth gate signal EMB of a first level voltage.

The first driving voltage ELVDD may be supplied to the first terminal of the first transistor T1 by the turned-on fifth transistor T5, and a voltage of the second terminal of the first transistor T1 may be changed to the first driving voltage ELVDD. The first node N1 may be floating due to the turned-off third transistor T3, and a gate voltage of the first transistor T1 may be a voltage Vobs+ELVDD-Vdata+Vth_tc that is changed by the amount of voltage change of the second terminal of the first transistor T1 from the bias voltage Vobs due to a coupling effect of the capacitor C.

The light-emitting diode ED may output a driving current Id∝(Vgs−Vth_t1)² having a value corresponding to a voltage Vgs−Vth_t1 obtained by subtracting a threshold voltage Vth_t1 of the first transistor T1 from the gate-source voltage Vgs of the first transistor T1. Because the gate-source voltage Vgs of the first transistor T1 is Vobs+ELVDD-Vdata+Vth_tc-ELVDD, and the threshold voltage Vth_tc of the seventh transistor Tc is the threshold voltage Vth_t1 of the first transistor T1, the driving current Id may be proportional to (Vobs−Vdata)². The driving current Id may be related to the data voltage Vdata but may not be related to the threshold voltage Vth_t1 of the first transistor T1. The driving current Id may flow to the light-emitting diode ED through the turned-on sixth transistor T6, and the light-emitting diode ED may emit light at a luminance corresponding to the driving current Id.

In a pixel (comparative pixel) including the capacitor C and a second capacitor connected in series to the capacitor C, the transmission rate of a data signal may decrease due to the distribution of data voltage according to the capacity ratio of capacitors, and power consumption may increase to compensate for the degraded data signal. In some example embodiments, during the second period P2, the threshold voltage Vth_tc of the seventh transistor Tc may be detected based on the data signal Data, and the compensation voltage Vdata-Vth_tc may be transferred to the second terminal of the first transistor T1 by the seventh transistor Tc and stored in the capacitor C. The pixel PX according to one or more example embodiments may include a single capacitor and a copying transistor of a driving transistor, and accordingly, a data signal may be directly transmitted to the second terminal of the first transistor T1 without the distribution of data voltage according to the capacity ratio of capacitors, and thus, the transmission rate of the data signal may be prevented from decreasing, and/or power consumption of a display device may be reduced.

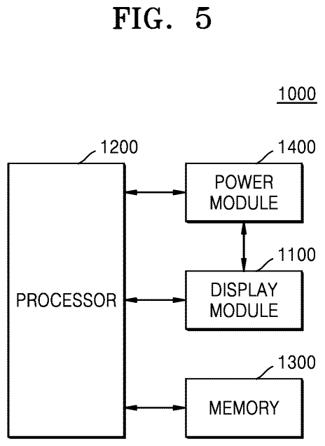

FIG. 5 is a block diagram of an electronic device 1000 according to some example embodiments.

Referring to FIG. 5, the electronic device 1000 according to some example embodiments may include a display module 1100, a processor 1200, a memory 1300, and a power module 1400.

The electronic device 1000 may output various information through the display module 1100 within an operating system.

The processor 1200 may include at least one of a central processing unit (CPU), an application processor (AP), a graphics processing unit (GPU), a communication processor (CP), an image signal processor (ISP), and a controller. However, example embodiments are not limited thereto. In some example embodiments, the processor 1200 may be split into two or more from a functional or structural perspective. For example, the processor 1200 may include a main processor in the form of a first drive chip including a CPU, and an auxiliary processor in the form of a second drive chip including a controller configured to receive an image signal from the main processor and process the image signal to meet interface specifications of the display module 1100.

The memory 1300 may include at least one of a non-volatile memory and a volatile memory. Data information required for an operation of the processor 1200 or the display module 1100 may be stored in the memory 1300. When the processor 1200 executes an application stored in the memory 1300, an image data signal and/or an input control signal may be transmitted to the display module 1100, and the display module 1100 may process the received signal and output image information through a display screen.

The power module 1400 may include a power supply module, such as a power adapter or a battery device, and a power conversion module configured to convert power supplied by the power supply module to generate power required for an operation of the electronic device 1000. Power conversion by the power conversion module may include, but is not limited to, DC-DC conversion, AC-DC conversion, and DC-AC conversion.

At least one of the elements of the electronic device 1000 described above may be included in a display device according to the previous example embodiments. In some example embodiments, some of the individual modules functionally included in one module may be included in the display device, and the others may be provided separately from the display device. For example, the display device may include the display module 1100 and the auxiliary processor of the processor 1200, and the main processor of the processor 1200, the memory 1300, and the power module 1400 may be provided in the form of another device within the electronic device 1000 other than the display device. As another example, the power module 1400 may be provided in the display device and may supply power to the processor 1200 and the memory 1300 provided in the electronic device 1000 other than the display device, and one or more example embodiments are not limited thereto.

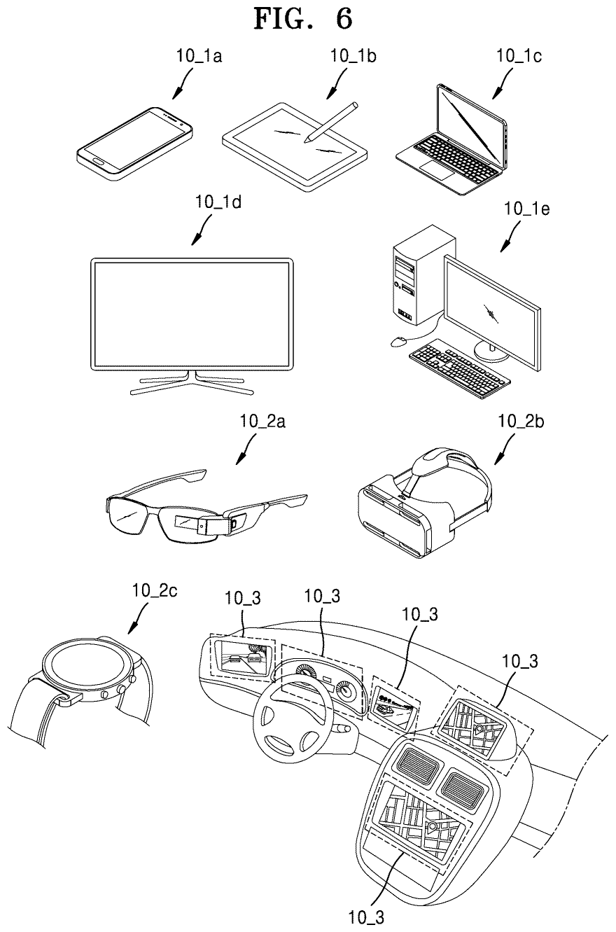

FIG. 6 is a schematic diagram of electronic devices according to various example embodiments.

A display device according to some example embodiments is a device that displays a moving image or still image, and may be applied to various electronic devices. Referring to FIG. 6, various electronic devices to which the display device according to some example embodiments is applied may include not only electronic devices for image display, such as a smartphone 10_1a, a tablet personal computer (PC) 10_1b, a laptop 10_1c, a television (TV) 10_1d, and a desk monitor 10_1e, but also wearable electronic devices including display modules such as smart glasses 10_2a, a head-mounted display 10_2b, and a smartwatch 10_2c, and automotive electronic devices 10_3 including display modules such as a car's instrument cluster, a center information display (CID) arranged on a car's center fascia or dashboard, and a room mirror display. The electronic device 1000 according to some example embodiments is not limited to the devices described above.

The electronic device of FIG. 6 may include the elements shown in FIG. 5. For example, the smartphone 10_1a may include the display module 1100, the processor 1200, the memory 1300, and the power module 1400 shown in FIG. 5. The smartphone 10_1a may further include a communication module and a battery device. Power provided from the battery device may be converted through the power module 1400 and provided to the processor 1200, the memory 1300, and the display module 1100. In some example embodiments, the display device applied to the smartphone 10_1a may include the display module 1100 and may further include the power module 1400. The processor 1200 and the memory 1300 may be provided in the form of chips mounted on a motherboard, which is an external device, but example embodiments are not limited thereto.

According to one or more example embodiments, a high-resolution display device with reduced power consumption may be provided. However, one or more example embodiments are not limited by such an effect.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

It should be understood that the example embodiments described herein should be considered in a descriptive sense only and not for purposes of limitation. Descriptions of features or aspects within each example embodiment should typically be considered as available for other similar features or aspects in other example embodiments. While one or more example embodiments have been described with reference to the figures, it will be understood by those of ordinary skill in the art that various changes in form and details may be made therein without departing from the spirit and scope as defined by the following claims.

What is claimed is:

1. A pixel comprising:
a first transistor;
a second transistor connected to a first terminal of the first transistor and a first voltage line;
a third transistor connected to a second terminal of the first transistor;
a fourth transistor connected to a gate of the first transistor and a second voltage line;
a fifth transistor connected to the second terminal of the first transistor and a light-emitting element;
a sixth transistor connected to the third transistor and a data line; and
a capacitor connected to the gate of the first transistor and the second terminal of the first transistor,
wherein the first transistor and the sixth transistor have a same structure.

2. The pixel of claim 1, wherein a gate of the sixth transistor is connected to the data line.

3. The pixel of claim 1, wherein the third transistor is connected between the second terminal of the first transistor and the sixth transistor.

4. The pixel of claim 1, further comprising a seventh transistor connected to the light-emitting element and the second voltage line.

5. The pixel of claim 1, wherein the first to sixth transistors include a same channel type.

6. The pixel of claim 1, wherein the first to sixth transistors are N-channel transistors.

7. The pixel of claim 1, wherein the third transistor and the fourth transistor are configured to transmit a data signal from the data line, through the sixth transistor, to the second terminal of the first transistor during a writing period in which the third transistor and the fourth transistor are turned on.

8. The pixel of claim 7, wherein
the second terminal of the first transistor is configured to receive a compensation voltage during the writing period, and
the compensation voltage being a difference between a voltage corresponding to the data signal and a threshold voltage of the sixth transistor.

9. The pixel of claim 8, wherein
the gate of the first transistor is configured to receive the compensation voltage during an emission period following the writing period and in which the second transistor and the fifth transistor are turned on, and the second transistor and the fifth transistor are turned on.

10. The pixel of claim 4, wherein
the fourth transistor, the fifth transistor, and the seventh transistor are configured to be turned on during a first period, and the second transistor and the third transistor are configured to be turned off during the first period,
the third transistor and the fourth transistor are configured to be turned on during a second period, and the second transistor, the fifth transistor, and the seventh transistor are configured to be turned off during the second period, and
the second transistor and the fifth transistor are configured to be turned on during an emission period following the second period, and the third transistor, the fourth transistor, and the seventh transistor are configured to be turned off during the emission period.

11. A display panel including a plurality of pixels,
each of the plurality of pixels comprising:
a first transistor;
a second transistor connected to a first terminal of the first transistor and a first voltage line;
a third transistor connected to a second terminal of the first transistor;
a fourth transistor connected to a gate of the first transistor and a second voltage line;
a fifth transistor connected to the second terminal of the first transistor and a light-emitting element;
a sixth transistor connected to the third transistor and a data line; and
a capacitor connected to the gate of the first transistor and the second terminal of the first transistor,
wherein the first transistor and the sixth transistor have a same structure.

12. The display panel of claim 11, wherein a gate of the sixth transistor is connected to the data line.

13. The display panel of claim 11, wherein each of the plurality of pixels further comprises a seventh transistor connected to the light-emitting element and the second voltage line.

14. The display panel of claim 11, wherein the first to sixth transistors are N-channel transistors.

15. The display panel of claim 11, wherein the third transistor and the fourth transistor are configured to transmit a data signal from the data line, through the sixth transistor, to the second terminal of the first transistor during a writing period in which the third transistor and the fourth transistor are turned on.

16. The display panel of claim 15, wherein
the second terminal of the first transistor is configured to receive a compensation voltage during the writing period, and
the compensation voltage being a difference between a voltage corresponding to the data signal and a threshold voltage of the sixth transistor.

17. The display panel of claim 16, wherein
the gate of the first transistor is configured to receive the compensation voltage during an emission period following the writing period and in which the second transistor and the fifth transistor are turned on, and the second transistor and the fifth transistor are turned on.

18. An electronic device comprising:
a controller configured to receive an on-operation signal from a processor and output a control signal based on the on-operation signal;
a gate driver configured to receive the control signal and sequentially output at least one gate signal; and
a display panel including a plurality of pixels configured to receive the at least one gate signal,
wherein each of the plurality of pixels comprises
a first transistor,
a second transistor connected to a first terminal of the first transistor and a first voltage line;
a third transistor connected to a second terminal of the first transistor;
a fourth transistor connected to a gate of the first transistor and a second voltage line;
a fifth transistor connected to the second terminal of the first transistor and a light-emitting element;
a sixth transistor connected to the third transistor and a data line;
a seventh transistor connected to the light-emitting element and the second voltage line; and
a capacitor connected to the gate of the first transistor and the second terminal of the first transistor,
wherein the first transistor and the sixth transistor have a same structure.

19. The electronic device of claim 18, wherein a gate of the sixth transistor is connected to the data line.

20. The electronic device of claim 18, wherein
the gate driver is configured to
supply a first gate signal including a first gate-on voltage to a gate of the fourth transistor during a first period,
supply a second gate signal including a second gate-on voltage to a gate of the fifth transistor during the first period,
supply a third gate signal including a third gate-on voltage to a gate of the seventh transistor during the first period,
supply a fourth gate signal including a fourth gate-on voltage to a gate of the third transistor during a second period following the first period,
supply the first gate signal including the first gate-on voltage to the gate of the fourth transistor during the second period,
supply a fifth gate signal including a fifth gate-on voltage to a gate of the second transistor during an emission period following the second period, and
supply the second gate signal including the second gate-on voltage to the gate of the fifth transistor during the emission period, and
wherein
the first transistor and an electrode of the light-emitting element of each of the plurality of pixels are configured to receive a voltage input to the second voltage line during the first period,
the second terminal of the first transistor is configured to receive, through the sixth transistor, a compensation voltage during the second period, the compensation voltage being a difference between a voltage corresponding to a data signal input to the data line and a threshold voltage of the sixth transistor, and
the gate of the first transistor is configured to receive the compensation voltage during the emission period, and light is emitted at a luminance corresponding to a driving current based on the compensation voltage.
